(19) United States
(12) Patent Application Publication
(10) Pub. No.: US 2009/0155008 A1
(43) Pub. Date: Jun. 18, 2009

(54) DRILLING TOOL, IN PARTICULAR FOR METALLIC MATERIALS

(76) Inventor: Peter Kopton, Kösching (DE)

Correspondence Address: Novak Druce & Quigg LLP, 1300 I Street NW, Suite 1000 West Tower, Washington, DC, 20005, US

(21) Appl. No.: 12/304,346

(22) PCT Filed: Jun. 6, 2007
(86) PCT No.: PCT/EP2007/005011

§ 371 Date: Dec. 11, 2008

(30) Foreign Application Priority Data
Jun. 14, 2006 (DE) 10 2006 027 552.7

(51) Int. Cl. B23B 51/06; B23B 31/10; B23B 51/00

(52) U.S. Cl. 408/59; 408/240; 408/229

(57) ABSTRACT

The invention relates to a drilling tool, in particular for metallic materials, having a clamping shaft and an essentially cylindrical drill body, between whose face side and the clamping shaft at least one groove-shaped chip space extends which is bordered by the side walls, of which one side wall on the face side of the drill body bears a cutting element. The side wall which bears the cutting element has a web which is drawn up from the side wall in the peripheral direction and which extends in the longitudinal direction of the drill.

The invention relates to a drilling tool, in particular for metallic materials.

### BACKGROUND OF THE INVENTION

These drilling tools are used in automotive engineering, for example in the production of cylinder head holes, for drilling out of a solid material or for enlarging already prefabricated drill holes.

Thus EP 0 750 960 B1 discloses a generic drilling tool which has a conventional clamping shaft and an adjoining cylindrical drill body. Between the face side of the drill body and the clamping shaft there extend two groove-shaped chip spaces. They are each bordered by side walls, of which one side wall at a time bears a cutting element on the face side of the drill body. Shavings from the drill hole are discharged to the outside in the two chip spaces during the drilling process.

The side wall of the respective chip space, which wall bears the cutting element, is made planar here and ends flush with the top of the cutting element. The two chip spaces extend partially helically in the longitudinal axis of the drill body.

This partially helical pattern of the chip spaces and the radially open configuration of the chip spaces adversely affect the discharge of shavings from the drill hole. Thus the shavings can be forced to the drilling wall as a result of the centrifugal force. Especially in a prefabricated cylinder head hole in whose walls there are cavities such as pockets or transverse holes, this has the disadvantage that shavings stick in the cavities. The shavings must therefore be manually cleared from the cavities after the drilling process, in a time-consuming procedure, in order to ensure their serviceability.

The object of the invention is to devise a drilling tool, in particular for metallic materials, in which the shavings which form during the drilling process are reliably removed from the holes.

### SUMMARY OF THE INVENTION

According to the invention, the side wall which bears the cutting element has a web which is drawn up from the side wall in the peripheral direction and which extends in the longitudinal direction of the drill. The web which is drawn up in the peripheral direction at least partially closes the chip space on the outside. The shavings transported through the chip space during the drilling process are thus not forced against the drill wall as a result of centrifugal force, but against the web so that the shavings are discharged without contact relative to the drill wall.

The web according to the invention can thus border the chip space to the outside in the radial direction. It is especially preferable if the web is formed on the outer peripheral side edge of the side wall. The groove which has thus been formed between the web and the opposite side wall of the chip space is thus made relatively wide, i.e., it is larger than the width of the split and/or unsplit shavings.

According to the invention, the resulting shavings are thus pressed as a result of the acting centrifugal forces into the groove which can extend preferably in a straight line, without coiling, in the longitudinal direction of the drill body. This straight groove promotes prompt discharge of shavings.

To form the aforementioned groove, the web in one embodiment with its upper edge can end essentially flush with the top of the cutting element. In this case, the groove which is bordered by the web with its groove bottom is displaced to the rear relative to the cutting element in the direction of rotation of the drilling tool. The shavings can thus be pressed reliably into the groove as a result of the acting centrifugal force.

According to another embodiment, the web can alternatively project over the top of the cutting element, as a result of which accordingly the groove height can be easily raised. In this connection the bottom of the groove formed between the web and the opposite side wall of the chip space can end essentially flush with the top of the cutting element. In order to support the transport of shavings from the face-side cutting element out of the chip space, the depth of the groove formed between the web and the opposite side wall of the chip space can be increased in the direction of the clamping shaft.

As already mentioned, it is especially preferred if the groove which is bordered by the web runs between the face side of the drill body and the clamping shaft. In this way a trough-shaped chip space is made available without any coiling, which runs in a straight line and which enables prompt removal of the shavings. The radial angle of the side walls of the chip space can be zero in this case.

The conveyance of the shavings through the chip space is further promoted when the side walls of the chip space are made planar and/or are arranged essentially at a right angle to one another. Preferably the groove formed between the web and the opposite side wall of the drill body can be laterally opened on the shaft side with an outlet in order to enable conveyance of the shavings out of the chip space.

Discharge of the chips can be supported by the use of a coolant which is routed with high pressure in the region of the face side of the drilling tool out of the coolant exit into the chip space and flushes the chips out of the hole.

According to the invention, the coolant can be routed with high pressure by way of a first coolant exit and a second coolant exit into the chip space. The two coolant exits can be positioned to one another such that the resulting shavings spaced apart from the drill wall in the region of an apex are bunched between the walls of the chip space.

Bunching of the resulting shavings can be supported using the emerging coolant flows when the two coolant channels discharge into different side walls of the chip space.

To supply the drilling tool with coolant, the drilling tool can have at least one central coolant line, from which a first and a second coolant channel branch off. Alternatively the central coolant line can be flow-connected by way of a transverse hole to the first and the second coolant channel. In this case, the first coolant channel can discharge as a main channel with a larger flow cross section into the side wall of the chip space which is opposite the web. The second coolant channel can discharge as a secondary channel with a smaller flow cross section into the side wall which bears the cutting element. The arrangement of the second coolant channel underneath the cutting element can further support discharge of the shavings and bunching of the shavings in the apex area.

The flow velocity of the coolant emerging from the channels in the longitudinal direction of the drill body depends on the volumetric flow and on the exit diameter of the coolant channels. An additional coolant velocity component is produced by the centrifugal force when the drilling tool is rotating. The light flow velocity of the coolant leads to a low static pressure of the coolant, resulting in the production of a suction action in the chip space. A large dynamic pressure which arises as a result of the high flow velocity causes the coolant to be able to efficiently remove the shavings from the chip space.

### BRIEF DESCRIPTION OF THE DRAWINGS

Three embodiments of the invention are described below using the attached figures.

FIG. 1 shows in a lateral view a drilling tool according to the first embodiment;

FIG. 2 shows the face side of the drilling tool in a front view;

FIG. 3 shows detail X from FIG. 1, enlarged;

FIG. 4 shows a view corresponding to FIG. 2 according to the second embodiment;

FIG. 5 shows a view corresponding to FIG. 3;

FIG. 6 shows a view corresponding to FIG. 2 according to the third embodiment; and

FIG. 7 shows the face side of the drilling tool according to the third embodiment.

### DETAILED DESCRIPTION OF THE PREFERRED EMBODIMENT OF THE INVENTION

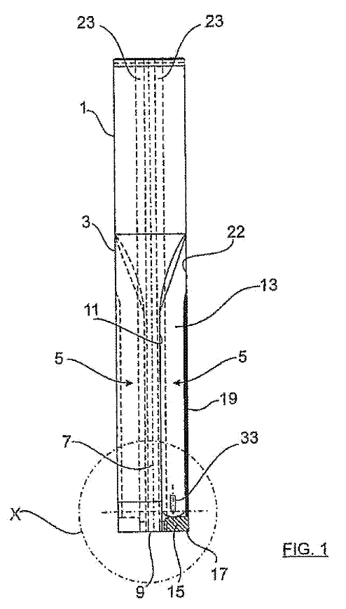

FIG. 1 shows a drilling tool for drilling in metallic workpieces according to the first embodiment. The drilling tool has a cylindrical clamping shaft 1 which conventionally adjoins the drill body 3. The drill body 3 has two essentially groove-shaped chip spaces 5 which extend to both sides of the longitudinal axis 7 of the drill body and discharge into the face surface 9 of the drill body 3. Each of the chip spaces 5 is bordered by two side walls 11 and 13.

Of the two side walls 11, 13 of the chip spaces 5, side wall 13 on its face end has a pocket-shaped recess in which a plate-shaped cutting element 15 sits, the top side thereof ending flush with the side wall 13. The cutting element 15 with its face-side cutting edge 17 projects slightly over the face surface 9 of the drill body 3 and radially protrudes slightly over the periphery of the drill body, as is indicated in FIG. 3.

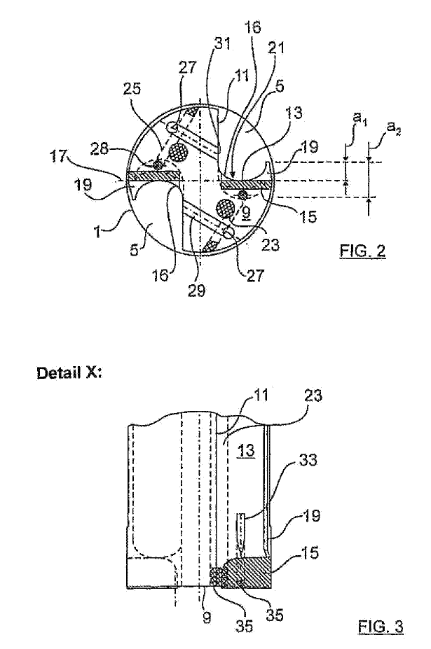

FIG. 2 shows the face surface 9 of the drill body 3 in a front view with the two opposite chip spaces 5. Accordingly, the two cutting elements 15 are located at the same radial distances to the longitudinal axis 7 of the drill body. The two side walls 11, 13 converge on a rounded apex 16 and are located essentially at a right angle to one another.

As follows further from FIG. 2, the radial angle between the transverse axis 17 and the cutting elements 15 is zero. That is, the cutting elements 15 are not arranged tilted in the peripheral direction, but are aligned in the direction of the radius of the drill body.

A web 19 is molded in each case onto the outer peripheral side edge of the side wall 13 of the respective chip space 5, which wall bears the cutting element 15. The web 19 is drawn up in the peripheral direction of the drilling tool and extends in the longitudinal direction of the drill as far as the clamping shaft 1. The web 19, as shown in FIG. 3 in the axial direction, directly adjoins behind the cutting element 15 and between itself and the opposite side wall 11 of the chip space 5 borders a groove 21 which runs in a straight line and which is U-shaped in cross section.

As follows from FIG. 2, the web 19 projects over the respective cutting element 15 in the peripheral direction so that the groove 21 with its bottom ends flush with the top of the cutting element 15. The groove bottom is formed by the side wall 13 which bears the cutting element 15.

As follows from FIG. 2, the groove 21 on its face-side end has a groove depth a₁ which increases in the direction of the clamping shaft 1 as far as a groove depth a₂ in order to support removal of shavings. Accordingly, the side wall 13 runs in the direction of the longitudinal axis 7 of the drill body tilted to the clamping shaft 1. In the region of the clamping shaft 1, the web 19 which laterally borders the groove 21 is interrupted so that the groove 21, as shown in FIG. 1, is laterally opened with an outlet 22 so that the resulting shavings can leave the respective chip space 5.

In order to supply the drilling tool with a coolant, in FIG. 1 two coolant lines 23 extend centrally through the drilling tool, of which each is assigned to a chip space 5. Each of the central coolant lines 23 is flow-connected as shown in FIG. 2 to a transverse hole 25 which divides the coolant into two separate coolant channels 27 and 28. The two coolant channels 27, 28 are each holes machined into the face surface 9 of the drill body. The coolant channel 27 therefore discharges into the face surface 9 of the drill body 3 and is routed in the face surface 9 as a branch channel 29 to the side wall 11, where it discharges in the first coolant exit 31 into the chip space 5. The second coolant channel 28 extends underneath the respective cutting element 15 in the direction of the longitudinal axis 7 of the drill body and with a second coolant exit 33 discharges in the obliquely running side wall 13.

FIGS. 1 to 3 each show the central lines 23 and the second coolant channels 28 on the face side, each closed by one threaded plug 35.

In a drilling process the resulting shavings, as a result of centrifugal force, are pressed into the groove 21 of the rotating drilling tool and therefore are held without contact relative to the drill wall by means of the web 19. As a result of the groove depth which rises from a₁ to a₂, transport of shavings in the direction of the groove outlet 22 is supported. Additional support of removal of the shavings takes place by the coolant which is fed with high pressure into the respective chip space 5 through the first coolant exit 31 as shown in FIG. 2 and the second coolant exit 33 as shown in FIG. 3 and additionally bunches the shavings in the region of the apex 16 between the two side walls 11, 13.

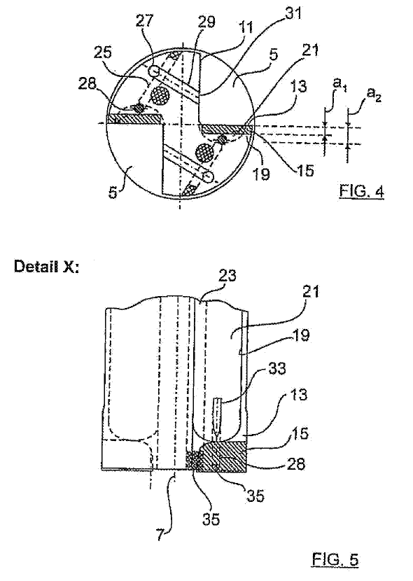

FIGS. 4 and 5 show a drilling tool according to the second embodiment, in contrast to the first embodiment of FIGS. 1 to 3, in the second embodiment the groove 21 is machined as a depression in the side wall 13. The groove 21 is thus set back in the direction of rotation of the tool relative to the cutting element 15 in the peripheral direction. The web 19 which is formed on the outer peripheral edge, with its top edge thus ends essentially flush with the top of the respective cutting element 15. The groove 21 is located with a groove depth a₁ in the axial direction directly behind the cutting element 15. It rises to a groove depth a₂ in the region of the clamping shaft 1.

The chip spaces 5 are supplied with coolant analogously to the first embodiment means of the central coolant lines 23 as well as the first and second coolant channels 27 and 28.

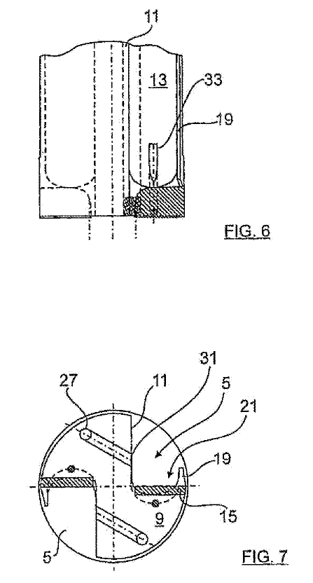

In the third embodiment of FIGS. 6 and 7, on the one hand the groove 21 is machined into the side wall 13 as a depression and thus the groove bottom is set back relative to the cutting element 15, as is the case in the second embodiment of FIGS. 4 and 5. Moreover, the web 19 which borders the groove 21 is drawn up beyond the cutting element 15 in the peripheral direction, as is the case in the first embodiment.

This yields a groove depth which has been increased compared to the first and second embodiment, as a result of which the resulting shavings can be discharged even more reliably from the drill hole in the groove 21, and therefore without contact relative to the drill wall.

1. A drilling tool, in particular for metallic materials, having a clamping shaft and an essentially cylindrical drill body, between whose face side and the clamping shaft at least one groove-shaped chip space extends which is bordered by the side walls, of which one side wall on the face side of the drill body bears a cutting element, wherein the side wall which bears the cutting element has a web which is drawn up from the side wall in the peripheral direction and which extends in the longitudinal direction of the drill.

2. The drilling tool according to claim 1, wherein the web borders the chip space to the outside in the radial direction.

3. The drilling tool according to claim 1 wherein the web is molded onto the outer peripheral side edge of the side wall.

4. The drilling tool according to claim 1 wherein the web together with the opposite side wall of the chip space forms a groove which extends in the longitudinal directions of the drill body.

5. The drilling tool according to claim 1 wherein at least one of the groove and the web of the side wall which bears the cutting element in the axial direction is located behind the cutting element.

6. The drilling tool according to claim 1 wherein the web with its top edge ends essentially flush with the top of the cutting element.

7. The drilling tool according to claim 1 wherein the web with its top edge projects over the top of the cutting element.

8. The drilling tool according to claim 7 wherein the bottom of the groove formed between the web and the opposite side wall of the chip space (5) ends essentially flush with the top of the cutting element.

9. The drilling tool according to claim 4 wherein the bottom of the groove is set back in the direction of rotation of the drilling tool relative to the cutting element.

10. The drilling tool according to claim 4 wherein the depth of the groove which has been formed between the web and the opposite side wall of the chip space changes in the direction of the clamping shaft.

11. The drilling tool according to claim 1 wherein the radial angle of the side walls of the chip space is zero.

12. The drilling tool according to claim 1 wherein at least one of the side walls of the chip space are made planar and are arranged essentially at a right angle to one another.

13. The drilling tool according to claim 1 wherein the groove formed between the web and the opposite side wall of the chip space runs in a straight line between the face side of the drill body and the clamping shaft in the axial direction.

14. The drilling tool according to claim 1 wherein the web is interrupted on the shaft side with an outlet in order to enable conveyance of shavings out of the chip space.

15. The drilling tool, in particular according to claim 1 wherein at least one first coolant channel which discharges with a first coolant exit into the chip space of the drilling tool, wherein at least one second coolant channel which discharges with a second coolant exit into the chip space is assigned to the chip space.

16. The drilling tool according to claim 15 wherein the first and the second coolant channels branch off from a central coolant line in the drilling tool.

17. The drilling tool according to claim 15 wherein the first coolant channel and the second coolant channel discharge into different side walls of the chip space.

18. The drilling tool according to claim 1 wherein the first coolant channel discharges as a main channel into the side wall which is opposite the web.

19. The drilling tool according to claim 18 wherein the second coolant channel discharges as a secondary channel into the side wall which bears the cutting element.

20. The drilling tool according to claim 19 wherein the second coolant channel runs underneath the cutting element.

21. A drilling tool comprising:
a shaft rotatable about an axis thereof; and
at least one cutting bit mounted on an end of said shaft having a leading surface relative to a direction of rotation of said shaft, disposed in a plane disposed radially relative to said axis;
wherein said shaft includes a passageway provided with an inlet disposed adjacent said cutting bit, an outlet spaced from said inlet and at least a portion of a side wall being curved in a plane disposed perpendicular to said axis.

22. A drilling tool according to claim 21 wherein a portion of said curved wall includes a trough abutting said leading surface of said cutting bit.

23. A drilling tool according to claim 22 wherein said portion of said curved wall includes segments disposed on leading sides of said leading surface of said cutting bit.

24. A drilling tool according to claim 21 wherein said shaft includes a second passageway communicating with said first mentioned passageway against said cutting bit for injecting a fluid under pressure for purging chips produced by said cutting bit and injected in said first mentioned passageway.

25. A drilling tool according to claim 24 wherein said second passageway also communicates with a cutting edge of said cutting tool.

26. A drilling tool according to claim 21 wherein a portion of said curved wall includes a trough segment disposed rearwardly relative to said leading surface of said cutting bit, relative to the direction of rotation of said shaft.

27. A drilling tool according to claim 26 wherein said shaft includes a second passageway communicating with said first passageway adjacent said cutting bit for injecting a fluid under pressure into said first passageway for purging chips produced by said cutting bit and injected into said first passageway.

28. A drilling bit according to claim 27 wherein said second passageway also communicates with a cutting edge of said cutting bit.

29. A drilling tool according to claim 26 wherein segments of said curved wall portion forming continuations of said trough segment are disposed forwardly relative to said leading surface of said cutting bit, relative to the direction of rotation of said shaft.

30. A drilling tool according to claim 21 including a second cutting bit having a leading surface disposed in the same plane as said leading surface of the other of said cutting bit.
